(19) United States
(12) Patent Application Publication
(10) Pub. No.: US 2014/0316755 A1
(43) Pub. Date: Oct. 23, 2014

(54) METHOD FOR PREDICTING OXIDATION REACTION RATE CONSTANT BETWEEN CHEMICALS AND OZONE BASED ON MOLECULAR STRUCTURE AND AMBIENT TEMPERATURE

(71) Applicant: DALIAN UNIVERSITY OF TECHNOLOGY, Liaoning (CN)

(72) Inventors: Xuehua Li, Liaoning (CN); Wenxing Zhao, Liaoning (CN); Jing Li, Liaoning (CN); Jingqiu Jiang, Liaoning (CN); Jingwen Chen, Liaoning (CN); Xianliang Qiao, Liaoning (CN); Xiyun Cai, Liaoning (CN)

(21) Appl. No.: 14/362,080

(22) PCT Filed: Nov. 30, 2012
(86) PCT No.: PCT/CN2012/085648

§ 371 Date: May 30, 2014

(30) Foreign Application Priority Data
Nov. 30, 2011 (CN) 201110392788.1

(51) Int. Cl. G06F 19/00

(52) U.S. Cl. CPC G06F 19/704
USPC 703/2

(57) ABSTRACT

This invention belongs to the technical field of quantitative structure-activity relationship (QSAR) for chemical persistent assessment, relating to a method for predicting reaction rate constants of organic chemicals with ozone (k_{O3}) at different temperatures. To assess the persistence and fate of organic chemicals in the troposphere, k_{O3} are needed. This invention developed a QSAR model for the prediction of k_{O3} at different temperatures, based on quantum chemical descriptors, Dragon descriptors and structural fragments. The developed model was evaluated by internal and external validations, and it's high robustness and good predictability was evidenced. The applicability domain of this model was visualized by Williams plot.

### FIELD OF THE INVENTION

This invention belongs to the technical field of quantitative structure-activity relationship (QSAR) for chemical persistence assessment, relating to a method for predicting reaction rate constants of organic chemicals with ozone (k_{O3}) at different temperatures.

### BACKGROUND OF THE INVENTION

Large numbers of organic chemicals have been emitted into the troposphere. These organic chemicals are expected to be removed by chemical degradation processes such as photolysis and reactions with tropospheric oxidants (O₃, OH. during the daytime and NO₃ radical at night). The lifetime of these organic chemicals can be calculated by the rate constants of theirs reaction with O₃, OH. and NO₃ radicals. Therefore, the reaction of organic chemicals with O₃ is a significant pathway determining their fate in the troposphere. And the rate constants for the reaction with ozone (k_{O3}) are needed to assess the atmospheric fate and persistence of organic chemicals.

The persistent assessment of organic chemicals is mostly on the base of experimental measurement, such as the determination of photolysis reactivity and reactive oxygen species (ROS). However, it is a huge financial pressure to obtain the experimental data of the chemicals. Meanwhile, synthetics increase at the rate of 500˜1000 species per year. Experimental measurement for each synthetic cannot meet the demand of environmental management. QSAR models are successful in predicting reaction kinetic parameters only from molecular structural information. Since QSAR models are cost-effective and independent of authentic chemical standards, they are crucial for persistence assessment of existing and new chemicals.

Several QSAR models have been developed for predicting k_{O3}. While these models have some limits in the aspects of robustness, predictive ability and applicability domain. Fatemi (Fatemi, M. H. Prediction of ozone tropospheric degradation rate constant of organic compounds by using artificial neural networks. Analytica Chimica Acta. 2006, 556: 355-363) developed a nonlinear QSAR model to predict k_{O3} of 137 organic chemicals at 298K by using artificial neural networks (ANN). The model has a sufficient goodness-of-fit and great predictive ability, but the algorithm is not transparent. One multiple linear regression (MLR) model (Pompe, M., Veber, M., Prediction of rate constants for the reaction of O₃ with different organic compounds. Atmospheric Environment. 2001, 35(22): 3781-3788) was developed to predict the reactivity of 117 heterogeneous chemicals using 6 molecular descriptors. Jiang et al. (Jiang, J. L., Yue, X. A., Chen, Q. F. Determination of ozonization reaction rate constants of aromatic pollutants and QSAR study. B. Environ. Contam. Tox. 2010, 85: 568-72) developed a QSAR model to predict k_{O3} of 39 aromatic compounds base on density functional theory (DFT). The model has a narrow applicability domain, which can only predict the aromatic compounds.

Thus, it is necessary to develop a QSAR model for predicting k_{O3} at different temperature. The model should be developed by a transparent algorithm whilst possesses a great robustness and predictability. Finally, the applicability domain of this model should be characterized.

### DETAILED DESCRIPTION OF THE INVENTION

The invention is to provide a method for predicting k_{O3} at different temperatures. The method should have these features: conciseness, rapidness, low-cost and wide applicability.

The details are as follows:

(1) To ensure the accuracy of the data for QSAR model development, assessment and analysis of the experimental values assembled from literatures are needed. Therefore, several experimental k_{O3} values of one chemical were firstly evaluated by statistics, in order to remove the large deviation value from the average. Secondly, the plotting of the logk_{O3} of one chemical at different temperatures against 1/T was analyzed to delete the large deviation value from the linear relationship. Finally, 264 logk_{O3} values for 129 organic compounds at different temperatures (178K˜364K) were comprised in the model. The classes of molecular descriptors in this model included 26 quantum chemical descriptors, 1481 Dragon descriptors and 12 molecular fragments. In addition, 1/T was added as a predictor variable in this model. The compounds include alkenes, cycloalkenes, haloalkenes, alkynes, oxygen-containing compounds, nitrogen-containing compounds (except primary amines) and aromatic compounds. The data were randomly divided into a training set and a validation set with a ratio of 4:1.

(2) MLR and PLS analysis methods were used to select optimal descriptors for the training set and build QSAR models. The following procedures were followed:

Firstly, stepwise MLR analysis was employed to select the significant descriptors. The MLR model was obtained with each descriptor having the variable inflation factor (VIF)<10.

Secondly, we performed a PLS regression analysis that manually eliminated the redundant descriptors and constructed an optimal model. Each descriptor was removed from the model development, respectively. The model with the maximum coefficient of determination R² and cumulative cross-validation coefficient Q²_{CUM} was selected for further eliminating the redundant descriptors in the next step. Here, Q²_{CUM} is the cumulative variance of the dependent variable that can be explained by the extracted PLS components. The optimum model was selected by repeating the above process until the R² and Q²_{CUM} do not increased. If the statistics R² and Q²_{CUM} of several models were at similar level, the model with the maximum adjusted coefficient of determination R²_{adj} was selected.

The obtained optimum PLS model is:

logk_{O3}=−12.542−493.3(1/T)+0.41722E_{HOMO}+0.4443_{electrophility}+0.66971n_{C═C}−0.26128qCₘₐₓ+0.74783BELm2+4.8412Mor32v+0.35198H3u+0.38372n_{═CHR}−1.7438n_{NH2}+0.4576n_{—CR2}−1.1235n_{BM}+0.28542n_{CIRCLE}

where, 1/T is the reciprocal of absolute temperature; E_{HOMO} is the energy of highest occupied molecular orbital; electrophility is the electrophilicity index; n_{C═C} is the number of carbon-carbon double bonds; qCₘₐₓ is the most positive charge of carbon; BELm2 is lowest eigenvalue n. 2 of Burden matrix/weighted by atomic masses; Mor32v is 3D-Morse-signal 32/weighted by atomic van der waals volumes; H3u is H autocorrelation of lag 3/unweighted; n_{═CHR} is the number of ═CHR (R represents non-cyclic alkyl substitutions, C represents the carbon atom of carbon-carbon double bonds); n_{NH2} is the number of —NH₂; n_{=CR2} is the number of ═CR₂ (R represents non-cyclic alkyl substitutions, C represents the carbon atom of carbon-carbon double bonds); n_{BM} is the number of methyl-substituents on the benzene rings; n_{CIRCLE} is the cyclic number of molecule (exclude conjugated rings).

The robustness and predictive ability of the k_{O3} model were evaluated by internal and external validations. The goodness of fit was characterized by adjusted determination coefficient and the root mean square error RMSE. The robustness was evaluated by internal cross-validation squared correlation coefficient Q²_{CUM}. The predictive ability of the model was evaluated by 50 external data, which were not used to develop the model. And the external validation coefficient Q²_{EXT} was used to describe predictive ability.

$${R}_{adj}^{2} = 1 - \frac{{\sum }_{i = 1}^{n} {( {y}_{i} - {\hat{y}}_{i} )}^{2} / ( n - p - 1 )}{{\sum }_{i = 1}^{n} {( {y}_{i} - \overline{y} )}^{2} / ( n - 1 )}$$

$$RMSE = \sqrt{\frac{{\sum }_{i = 1}^{n} {( {y}_{i} - {\hat{y}}_{i} )}^{2}}{n}}$$

$${Q}_{ext}^{2} = 1 - \frac{{\sum }_{i = 1}^{{n}_{EXT}} {( {\hat{y}}_{i} - {y}_{i} )}^{2}}{{\sum }_{i = 1}^{{n}_{EXT}} {( {y}_{i} - {\overline{y}}_{EXT} )}^{2}}$$

where ŷᵢ and yᵢ are the predicted value and observed value for the ith compound, respectively; y̅ is the response mean of the observed values in the training set; y̅_{EXT} is the response mean of the observed values in the validation set; n is the number of the objects in training set and p is the number of descriptors; n_{EXT} is the number of the objects in validation set.

The model statistics parameters, adjusted determination coefficient R²_{adj} of 0.849, the root mean square error RMSE of 0.562, the leave-group-out cross-validation squared correlation coefficient Q²_{CUM} of 0.838, the external validation coefficient Q²_{EXT} of 0.878 were obtained, which indicate satisfactory goodness of fit, robustness and predictive ability. Applicability domain of the model was characterized by the leverage approach using the Williams plot. The abscissa of the plot expresses the leverage (hᵢ) of each chemical and the standardized residual (σ) is on the vertical. The warning leverage (h*) of the developed model is 0.196. If σ of a compound is greater than 3 times the standard deviation units (±3.0), the compound will be treated as outliers.

This invention offered a low-cost, simple and rapid way to predict the k_{O3} values of various chemicals at different temperature. Model establishment and evaluation was performed according to the OECD guidelines. Thus, the k_{O3} values predicted by the model can be used to evaluate the persistence of the organic chemicals.

The developed k_{O3} predictive model in this invention is of several advantages: (1) The k_{O3} at different temperatures can be used for estimating the lifetime of pollutants in the troposphere. (2) The molecular descriptors in the k_{O3} predictive model can be obtained by simple calculating. (3) The built model possesses a great robustness and predictability. (4) The applicability domain of the model was characterized.

### FIGURE CAPTIONS

FIG. 1a. Plot of predicted versus experimental logk_{O3} values in the training set. The training set includes 214 logk_{O3} values of 110 compounds.

FIG. 1b. Plot of predicted versus experimental logk_{O3} values in the validation set. The validation set includes 50 logk_{O3} values of 33 compounds.

FIG. 2. Williams plot of standardized residuals versus leverages for characterizing the application domain of the k_{O3}model.

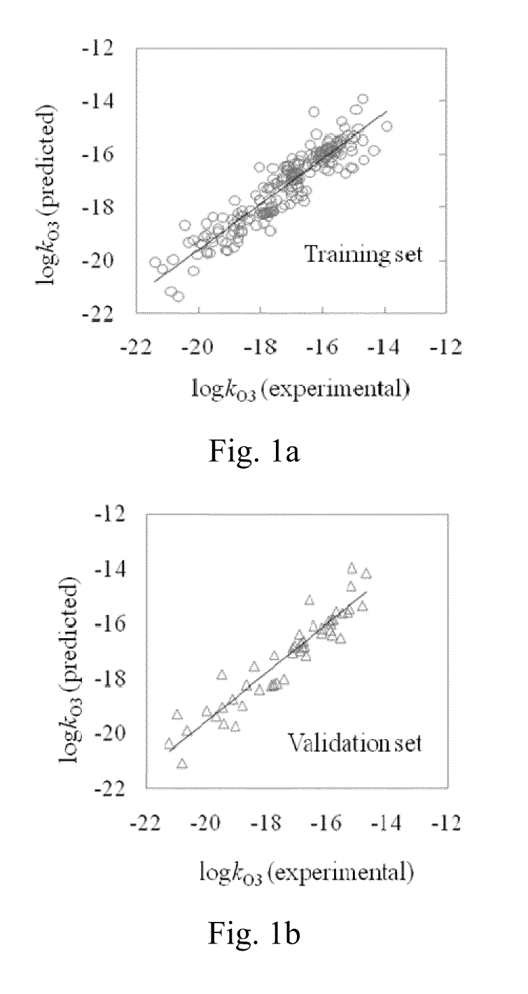

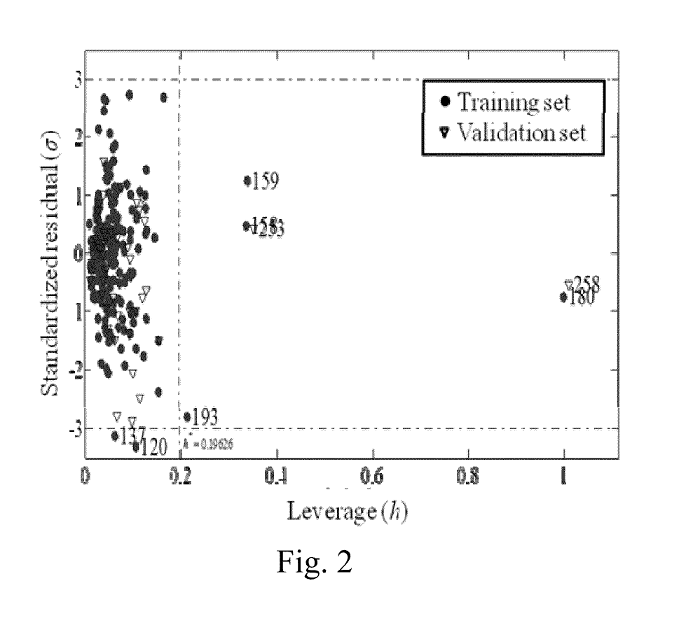

### EXAMPLES

### Example 1

1-heptylene: According to the calculated h (0.0576<h*) and σ (0.2838<3), the compound was considered to belong to the domain as defined by the Williams plot. 13 molecular descriptors in the predictive model were calculated by using the PM6 method embedded in MOPAC 2009 and DRGAN software (version 2.1) and considering the molecular fragments. The experimental logk_{O3} value of 1-heptylene at 296K is −16.76 cm³molecule⁻¹s⁻¹. The logk_{O3} value predicted by the QSAR model is:

$$\begin{matrix}log {k}_{O 3} = - 12.542 - 493.3 \times ( 0.003378 ) + 0.41722 \times \\ ( - 9.970 ) + 0.4443 \times ( - 1.6584 ) + \\ 0.66971 \times 1 - 0.26128 \times ( - 0.0611 ) + \\ 0.74783 \times 1.684 + 4.8412 \times ( - 0.128 ) + \\ 0.35198 \times 1.354 + 0.38372 \times 1 - 1.7438 \times 0 + \\ 0.4576 \times 0 - 1.1235 \times 0 + 0.28542 \times 0 \\ = - 16.92\end{matrix}$$

### Example 2

1,1-dichloroethylene: According to the calculated h (0.0616<h*) and σ (−3.12<−3), the compound was considered to be out of the domain as defined by the Williams plot. 13 molecular descriptors in the predictive model were calculated by using the PM6 method embedded in MOPAC 2009 and DRGAN software (version 2.1) and considering the molecular fragments. The experimental logk_{O3} value of 1,1-dichloroethylene at 298K is −20.43 cm³molecule⁻¹s⁻¹. The logk_{O3} value predicted by the QSAR model is:

$$\begin{matrix}log {k}_{O 3} = - 12.542 - 493.3 \times ( 0.003356 ) + 0.41722 \times \\ ( - 10.225 ) + 0.4443 \times ( - 2.5540 ) + \\ 0.66971 \times 1 - 0.26128 \times 0.0855 + \\ 0.74783 \times 0.000 + 4.8412 \times 0.058 + \\ 0.35198 \times 0.004 + 0.38372 \times 0 - 1.7438 \times 0 + \\ 0.4576 \times 0 - 1.1235 \times 0 + 0.28542 \times 0 \\ = - 18.67\end{matrix}$$

### Example 3

Camphene: According to the calculated h (0.213 >h*) and σ (−2.78>−3), the compound was considered to be out of the domain as defined by the Williams plot. 13 molecular descriptors in the predictive model were calculated by using the PM6 method embedded in MOPAC 2009 and DRGAN software (version 2.1) and considering the molecular fragments.

The experimental logk_{O3} value of camphene at 298K is −18.05 cm³molecule⁻¹s⁻¹. The logk_{O3} value predicted by the QSAR model is:

$$\begin{matrix}log {k}_{O 3} = - 12.542 - 493.3 \times ( 0.003356 ) + 0.41722 \times \\ ( - 9.663 ) + 0.4443 \times ( - 1.5099 ) + \\ 0.66971 \times 1 - 0.26128 \times 0.1549 + \\ 0.74783 \times 1.705 + 4.8412 \times ( - 0.196 ) + \\ 0.35198 \times 1.246 + 0.38372 \times 0 - 1.7438 \times 0 + \\ 0.4576 \times 1 - 1.1235 \times 0 + 0.28542 \times 2 \\ = - 16.48\end{matrix}$$

### Example 4

According to the calculated h (1.0115 >h*) and σ (−0.54>−3), the compound was considered to be out of the domain as defined by the Williams plot. 13 molecular descriptors in the predictive model were calculated by using the PM6 method embedded in MOPAC 2009 and DRGAN software (version 2.1) and considering the molecular fragments.

The experimental logk_{O3} value of methylamine at 296K is −19.67 cm³molecule⁻¹s⁻¹. The logk_{O3} value predicted by the QSAR model is:

$$\begin{matrix}log {k}_{O 3} = - 12.542 - 493.3 \times ( 0.003378 ) + 0.41722 \times \\ ( - 9.415 ) + 0.4443 \times ( - 0.6806 ) + \\ 0.66971 \times 0 - 0.26128 \times ( - 0.3390 ) + \\ 0.74783 \times 0.750 + 4.8412 \times 0.031 + \\ 0.35198 \times 0.083 + 0.38372 \times 0 - 1.7438 \times 1 + \\ 0.4576 \times 0 - 1.1235 \times 0 + 0.28542 \times 0 \\ = - 19.35\end{matrix}$$

### Example 5

According to the calculated h (0.0658<h*) and σ (0.2707<−3), the compound was considered to belong to the domain as defined by the Williams plot. 13 molecular descriptors in the predictive model were calculated by using the PM6 method embedded in MOPAC 2009 and DRGAN software (version 2.1) and considering the molecular fragments.

The experimental logk_{O3} value of ethyl nitrite at 310K is −18.80 cm³molecule⁻¹s⁻¹. The logk_{O3} value predicted by the QSAR model is:

$$\begin{matrix}log {k}_{O 3} = - 12.542 - 493.3 \times ( 0.003226 ) + 0.41722 \times \\ ( - 10.062 ) + 0.4443 \times ( - 2.9546 ) + \\ 0.66971 \times 0 - 0.26128 \times 0.0274 + \\ 0.74783 \times 0.909 + 4.8412 \times ( - 0.022 ) + \\ 0.35198 \times 0.349 + 0.38372 \times 0 - 1.7438 \times \\ 0 + 0.4576 \times 0 - 1.1235 \times 0 + 0.28542 \times 0 \\ = - 18.96\end{matrix}$$

We claim:

1. Based on molecular structural descriptors, a method for predicting reaction rate constants of organic chemicals with ozone (k_{O3}) at different temperatures was developed according to the following procedures:
(1) Firstly, several experimental k_{O3} values at the same temperature of one chemical were evaluated by statistics in order to remove large deviation value from the average, secondly, plotting of the logk_{O3} of one chemical at different temperatures against 1/T was performed to delete the large deviation value from the linear relationship, on basis of the aforementioned procedures 264 logk_{O3} values of 129 organic compounds at different temperatures (178K˜364K) were finally retrieved for model development, molecular descriptors in this model consist of 26 quantum chemical descriptors, 1481 Dragon descriptors and 12 molecular fragments, particularly, 1/T was also used as a predictor variable in the model.
(2) Multiple linear regression (MLR) and partial least-squares (PLS) analysis were used for descriptor selection and model development as shown in the following procedures:
Stepwise MLR analysis was initially employed in order to select significant descriptors, each descriptor in the derived MLR model has a variable inflation factor (VIF) less than 10,
Secondly, we performed a PLS regression analysis that manually eliminated the redundant descriptors and constructed an optimal model, each descriptor was removed from the model development, respectively, the model with the maximum coefficient of determination R² and cumulative cross-validation coefficient Q²_{CUM} was selected for further eliminating the redundant descriptors in the next step, here, Q²_{CUM} is the cumulative variance of the dependent variable that can be explained by the extracted PLS components, the optimum model was selected by repeating the above process until the R² and Q²_{CUM} do not increased, if the statistics R² and Q²_{CUM} of several models were at similar level, the model with the maximum adjusted coefficient of determination R²_{adj} was selected.
The developed optimum PLS model can be expressed as:
logk_{O3}=12.542−493.3(1/T)+0.41722E_{HOMO}+0.4443_{electrophility}+0.66971n_{C═C}−0.26128qCₘₐₓ+0.74783BELm2+4.8412Mor32v+0.35198 H3u+0.38372n_{═CHR}−1.7438n_{NH2}+0.4576n_{═CR2}−1.1235n_{BM}+0.28542n_{CIRCLE}
where 1/T is the reciprocal of absolute temperature; E_{HOMO} is the energy of highest occupied molecular orbital; electrophility is the electrophilicity index; n_{C═C} is the number of carbon-carbon double bonds; qCₘₐₓ is the most positive charge of carbon; BELm2 is lowest eigenvalue n. 2 of Burden matrix/weighted by atomic masses; Mor32v is 3D-Morse-signal 32/weighted by atomic van der waals volumes; H3u is H autocorrelation of lag 3/unweighted; n_{═CHR} is the number of ═CHR (R represents non-cyclic alkyl substitutions, C represents the carbon atom of carbon-carbon double bonds); n_{NH2} is the number of −NH₂; n_{═CR2} is the number of ═CR₂ (R represents non-cyclic alkyl substitutions, C represents the carbon atom of carbon-carbon double bonds); n_{BM} is the number of methyl-substituents on the benzene rings; n_{CIRCLE} is the cyclic number of molecule (exclude conjugated rings).

2. Base on the methods given in claim 1, the constructed model is a feasible tool for predicting k_{O3} value under different temperatures for a wide range of organic chemicals, e.g., alkenes, cycloalkenes, haloalkenes, alkynes, oxygen-containing compounds, nitrogen-containing compounds as well as aromatic compounds.
